(19) United States
(12) Patent Application Publication
(10) Pub. No.: US 2021/0058310 A1
(43) Pub. Date: Feb. 25, 2021

(54) SYSTEM AND METHOD FOR EVALUATING NETWORK QUALITY OF SERVICE

(71) Applicant: MARTELLO TECHNOLOGIES CORPORATION, Ottawa (CA)

(72) Inventor: Antoine ROUX, Paris (FR)

(21) Appl. No.: 16/810,470

(22) Filed: Mar. 5, 2020

Related U.S. Application Data
(60) Provisional application No. 62/888,739, filed on Aug. 19, 2019.

(51) Int. Cl. H04L 12/26; H04L 12/24

(52) U.S. Cl. CPC H04L 43/0823; H04L 43/16; H04L 41/0631; H04L 43/06; H04L 43/0811

(57) ABSTRACT

An example system includes: a plurality of endpoints; a network supporting events on the network, each event occurring at one of the plurality of endpoints; a network evaluation server coupled to the network, the server configured to: for each event: obtain a service score, an event type, and a user identifier for the event; and when the service score for the event does not exceed a threshold service score for the event type, assign a fail indication for the event; determine a network score based on a ratio of a number of user identifiers associated with at least one failed event to a total number of user identifiers associated with at least one event; and output an indication of the network score.

### CROSS-REFERENCE TO RELATED APPLICATION

This application claims the benefit of U.S. provisional patent application Ser. No. 62/888,739, filed Aug. 19, 2019, which is incorporated herein by reference.

### FIELD

The specification relates generally to networks, and more particularly to systems and methods for evaluating network quality of service.

### BACKGROUND

Networks interconnect systems of endpoints and enable services to be provided between the endpoints. Networks may be evaluated on the quality of service to identify areas of improvement in the networks.

### SUMMARY

According to an aspect of the present invention, an example system includes: a plurality of endpoint devices; a network supporting events on the network, each event occurring at one of the plurality of endpoint devices; a network evaluation server coupled to the network, the server configured to: for each event: obtain a service score, an event type, and a user identifier for the event; and when the service score for the event does not exceed a threshold service score for the event type, assign a fail indication for the event; determine a network score based on (i) a number of user identifiers associated with at least one failed event and (ii) a total number of user identifiers associated with at least one event; and output an indication of the network score.

According to another aspect of the present invention, a method includes: for each of a plurality of events on a network: obtaining a service score and an event type for the event; and when the service score for the event does not exceed a threshold service score for the event type, assigning a fail indication for the event; determining a network score for the network based on (i) a number of failed events and (ii) a total number of events; and outputting an indication of the network score.

According to another aspect of the present invention, a method includes: determining a network score for a network based on a number of failed events and a total number of events supported by the network; identifying one or more subsections of the network; and for each subsection of the network, determining a subsection score based on a number of failed events associated with the subsection and a total number of events associated with the subsection; and outputting an indication of the subsection score for each of the one or more subsections of the network.

### BRIEF DESCRIPTION OF DRAWINGS

Implementations are described with reference to the following figures, in which:

FIG. 1 depicts an example system for evaluating network quality of service;

FIG. 2 depicts certain internal components of certain components of the system of FIG. 1;

FIG. 3 depicts a flowchart of a method of evaluating network quality of service in the system of FIG. 1;

FIG. 4 depicts a flow diagram of data during the method of FIG. 3;

FIG. 5 depicts a method of generating a report in the system of FIG. 1; and

FIG. 6 depicts a schematic of subsections of the system of FIG. 1.

### DETAILED DESCRIPTION

The quality of service of networks may be scored based on key performance indicators at individual calls, events, sessions, transactions, or pieces of equipment. Further, these quality of service metrics generally correspond to the particular indicators of the event or equipment, and hence may be technical in nature. An example system includes a server to evaluate the network as a whole. The server obtains quality of service metrics and generates a binary evaluation (e.g. pass/fail) for each event serviced by the network and associates the event with a user identifier. A network score may thus be determined based on a ratio of users experiencing at least one failed event (i.e. user identifiers associated with at least one failed event) to a total number of users utilizing the network (i.e. user identifiers associated with least one event). In particular, the network score may be presented as a percentage in an intuitive manner to represent the quality of service of the network as a whole. The network score may further be subdivided into subsection scores for subsections of the network corresponding to distinct offices, regions, or categories to enable granular evaluation of the network.

A quality of service metric is important when allocating network resources to improve communications problems. Conventional approaches often attempt to quantify a large number of performance aspects of individual devices or events and blend or weight these many aspects together to arrive at a total metric. However, while such metrics may have accuracy, they are often too subtle or nuanced to efficiently act upon. A small difference between values of a conventional metric may misrepresent what is actually a critical failure in an important system that significantly affects perceived user experience, while another difference might actually represent a failure that goes unseen by the end user. The techniques discussed herein use a quality of service metric based on perceived user experience. The techniques use a pass/fail schema, among other things, as it was realized that the degree of failure of a call, event, session, transaction, or piece of equipment was less important information than the fact that the failure was perceived by the user. As such, the techniques discussed herein provide a quality of service metric that relies on perceived user experience. Within large systems where failures can have unpredictable effects, this metric helps focuses the technical support resources and effort on the problems that matter. Therefore, it improves the effectiveness of response to failures and improves the functioning of a network as a whole.

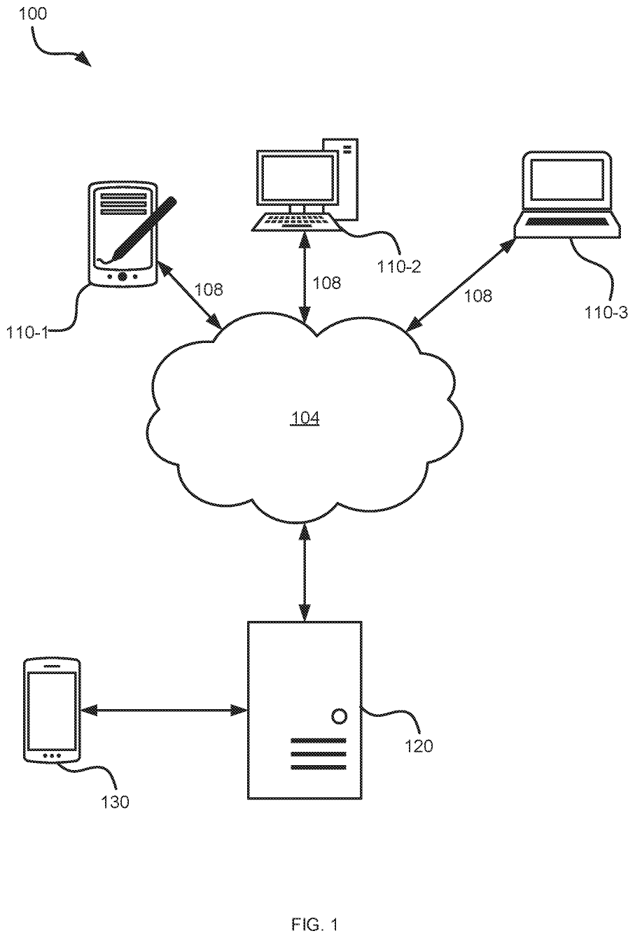

FIG. 1 depicts an example system 100 for evaluating a network 104. In particular, the system 100 determines a quality of service of the network 104 as a whole. The system 100 includes the network 104 connecting a plurality of endpoint devices 110-1, 110-2, and 110-3 (referred to herein generically as an endpoint device 110, and collectively as endpoint devices 110). More generally, in other examples, the system 100 may include more than three or fewer than three endpoint devices 110. The system 100 further includes a network evaluation server 120 connected to the network 104 to obtain event data associated with events supported on the network 104 and to evaluate the network 104.

The network 104 is generally configured to allow communications between and provide services to the endpoint devices 110. For example, the network 104 may be a telephony network, a computing network, or other suitable communications network. For example, the network 104 may include any one of, or any combination of, a local area network (LAN) defined by one or more routers, switches, wireless access points or the like, any suitable wide area network (WAN) including cellular networks and the internet, and the like. More particularly, the network 104 supports events at the endpoint devices 110. Each event represents one instance of a service provided to an endpoint device 110 by the network 104.

The endpoint devices 110 may be computing devices, such as servers, desktop computers, kiosks, and the like, or mobile computing devices, such as mobile phones, tablets, laptop computers, and the like. Generally, the endpoint devices 110 are capable of communicating over the network 104 via communication links 108. The communication links 108 may be wired or wireless, or a combination of wired and wireless, including direct links, or links that traverse one or more networks, including both local and wide area networks.

The server 120 is also connected to the network 104 to obtain event data associated with events supported on the network, and to evaluate the network based on the event data. Certain internal components of the server 120 will be described in greater detail below. The server 120 is also in communication with a client device 130 via a communication link which may include wired, or wireless links, including a wireless local area network, wide area networks, such as the Internet, mobile networks, or the like. The client device 130 may be a mobile computing device such as a tablet, smart phone, or the like, operated by an operator of the server 120.

In operation, users operating the endpoint devices 110 may access the network 104. The network 104 supports events occurring at the endpoint devices 110. During the events, event data is generated and sent to the server 120. The event data may include, for example, network metrics, service metrics, a service score, an event type, and a user identifier for a user of the endpoint device 110. The server 120 aggregates event data from events supported across the network 104 and determines a quality of service of the network 104 as a whole. More particularly, the server 120 aggregates the event data associated with user accounts to determine a quality of service of the network 104 as experienced by users utilizing the network.

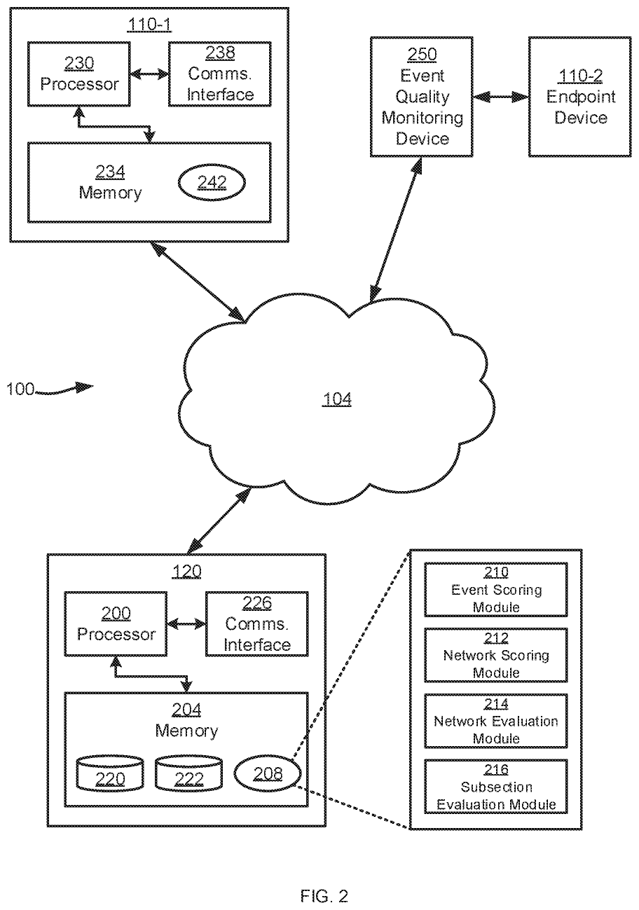

Referring to FIG. 2, certain internal components of the endpoint device 110-1 and the server 120 are depicted.

The server 120 includes a processor 200, such as a central processing unit, a microcontroller, a microprocessor, a processing core, a field-programmable gate array, multiple cooperating processors, or the like. The server 120 further includes a non-transitory computer-readable storage medium, such as a memory 204. The processor 200 may cooperate with the memory 204 to realize the functionality described herein. The memory 204 may include a combination of volatile (e.g., Random Access Memory) and non-volatile memory (e.g., read only memory, electrically erasable programmable read only memory, flash memory). All or some of the memory 204 may be integrated with the processor 200. The memory 204 stores a plurality of applications, each including a plurality of computer-readable instructions executable by the processor 200. The execution of the instructions stored in the applications by the processor 200 configures the server 120 to perform various actions described herein.

In particular, the memory 204 stores a network evaluation application 208 to evaluate the network 104. In particular, the network evaluation application 208 includes an event scoring module 210 to evaluate service scores for individual events, a network scoring module 212 to aggregate the service scores of events to generate a network score, a network evaluation module 214 to evaluate the network score and output an indication of the network score, and a subsection evaluation module 216 to evaluate subsections of the network. In some examples, the network evaluation application 208 may be implemented as a suite of applications.

The memory 204 further stores an event data repository 220 to store data. In particular, the event data repository 220 may store obtained from the endpoint devices 110 pertaining to events occurring at the endpoint devices 110. In particular, the event data repository 220 may include event types, service scores, user identifiers, time of occurrence, and other pertinent event data relating to each event. The event data repository 220 may further include a binary evaluation of the event (e.g., whether the event passed or failed a threshold quality level) generated by the server 120, as will be described further herein.

The memory 204 may further include an evaluation data repository 222 to be used to evaluate the events and the network 104. For example, the evaluation data repository 222 may include a threshold service score by event type. In particular, different events having different event types may have different service scores based on different factors, and accordingly the different event types may have different threshold service scores. Accordingly, the evaluation data repository 222 may store an association between the threshold service score and the event type. The evaluation data repository 222 may further include other threshold values for evaluating the events and the network 104, including, but not limited to, a predetermined time for which to evaluate the network 104, a threshold number of events for a meaningful evaluation of the network 104, one or more threshold network scores to determine a response level to the quality of the network 104, and the like.

The server 120 further includes a communications interface 226 interconnected with the processor 200. The communications interface 226 includes suitable hardware (e.g., transmitters, receivers, network interface controllers and the like) allowing the server 120 to communicate with other computing devices, such as the endpoint devices 110. The specific components of the communications interface 226 may be selected based on the type of the network 104 that the server 120 is to communicate over.

In some examples, the server 120 may further include one or more input/output devices (not shown), such as a monitor, display, keyboard, mouse, or the like to allow an operator to interface with the server 120.

The endpoint device 110-1 includes a processor 230, a memory 234, and a communications interface 238. The processor 230 may include a central processing unit (CPU), a microcontroller, a microprocessor, a processing core, or similar device capable of executing instructions. The processor 230 is interconnected with the memory 234. The memory 234 may include a non-transitory computer-readable storage medium that may include a combination of volatile and non-volatile memory. All or some of the memory 234 may be integrated with the processor 230. The memory 234 stores a plurality of applications, each including a plurality of computer-readable instructions executable by the processor 230.

The communications interface 238 is interconnected with the processor 230 and includes suitable hardware (e.g., transmitters, receivers, network interface controllers and the like) allowing the endpoint device 110-1 to communicate with other computing devices, such as other endpoint devices 110, or the server 120. The specific components of the communications interface 238 may be selected based on the type of communication link 108 that the endpoint device 110-1 communicates over.

In the present example, the endpoint device 110-1 also includes an integrated mechanism to monitor the quality of events at the endpoint device 110-1. In particular, the memory 234 stores an event quality monitoring application 242 to monitor the quality of events occurring at the endpoint device 110-1. The event quality monitoring application 242 monitors the event over the duration of the event and generates event data representing the quality of the event. For example, the event data may include a service score for the event evaluating a quality of service for the event. For example, the service score for a VoIP call may include a rating factor (r-factor) computed based on latency, jitter, packet loss, and the codec used during the VoIP call. For example, the event quality monitoring application 242 may obtain data from the communications interface 238 to determine a quality of the communication links 108 over which the event may be supported. In other examples, the service score may be based on other data, such as user feedback indicating the quality of the event. The event data may further include an event type of the event to identify different event types having different factors associated with the service score.

The endpoint device 110-1 may further include one or more input/output devices (not shown), such as a monitor, display, keyboard, mouse, or the like to allow a user to interface with the endpoint device 110-1. For example, the endpoint device 110-1 may include an input device (e.g., an integrated keyboard) to allow a user to provide a user identifier (e.g., a login, email, personal identification number, or other credentials) to enable network access for the endpoint device 110-1.

The endpoint device 110-2 may be similar to the endpoint device 110-1, or it may be another suitable computing device. In the present example, the endpoint device 110-2 is coupled to an event quality monitoring device 250.

The event quality monitoring device 250 monitors the event over its duration and generates event data representing the quality of the event. For example, the event quality monitoring device 250 may include the event quality monitoring application 242 to obtain event data during an event at the endpoint device 110-2. In particular, the event quality monitoring device 250 may be configured to obtain data from a communications interface (not shown) of the endpoint device 110-2, or to otherwise intercept or sample the quality of communications via the communication link 108 during the event. In other examples, communications to and from the endpoint device 110-2 may be routed through the event quality monitoring device 250 to allow the event quality monitoring device 250 to monitor the event.

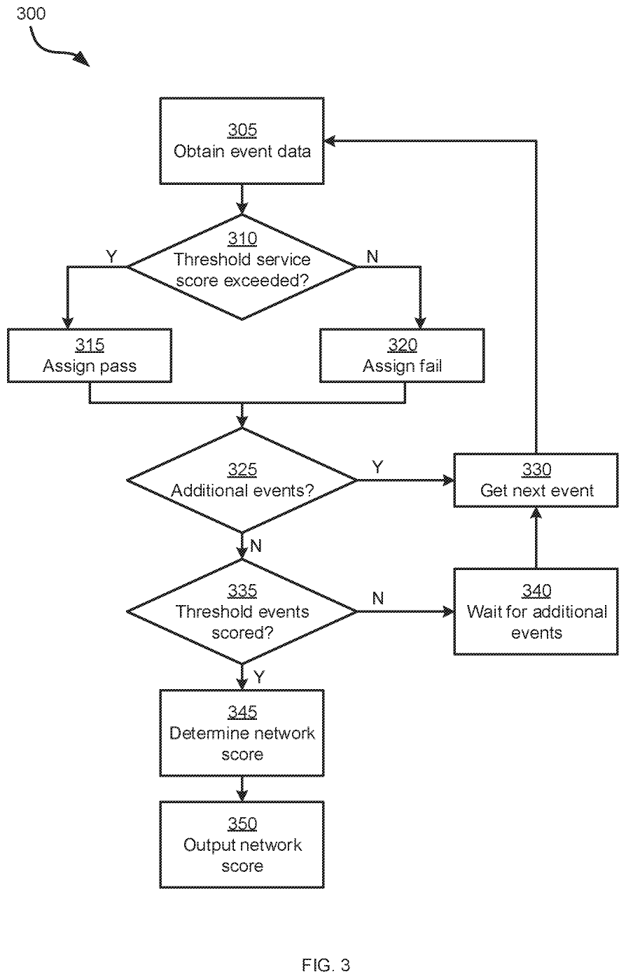

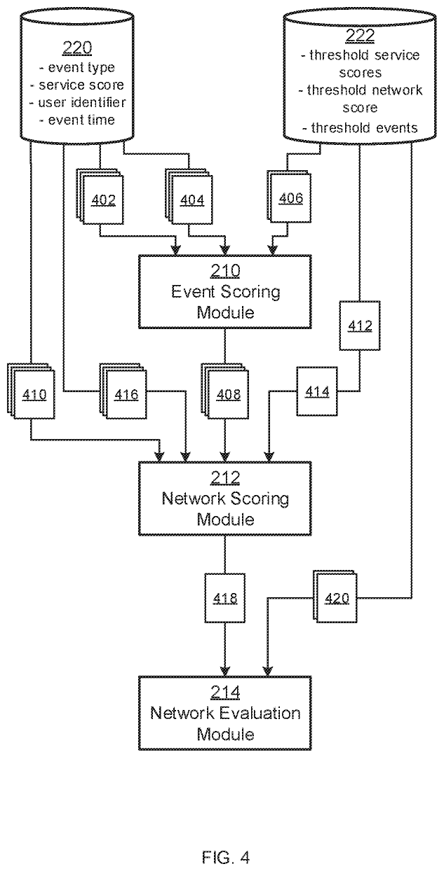

Referring now to FIG. 3, a flowchart of an example method 300 of evaluating a network is depicted. In particular, the performance of the network over a predetermined period of time is determined. The method 300 will be described in conjunction with its performance in the system 100, and in particular, by the server 120 via execution of the network evaluation application 208. It is contemplated that in other examples, the method 300 may be performed by other suitable systems. The method 300 will also be described in conjunction with FIG. 4, which depicts a schematic flow diagram of the flow of data during performance of the method 300.

The method 300 is initiated at block 305. For example, the method 300 may be initiated in response to a request for the network score, for example, based on input from an operator of the server 120. In other examples, the method 300 may be initiated at predetermined intervals, in response to receiving event data from the endpoint devices 110, or other suitable initiation conditions. At block 305, the server 120, and in particular, the event scoring module 210, obtains event data for an event occurring at an endpoint device 110. For example, in some examples, the server 120 may request the event data from the endpoint devices 110 and may obtain the event data in response to the request. In other examples, the endpoint device 110 may initiate transmission of the event data, for example, based on an event occurring at the endpoint device 110. The event data received from the endpoint device 110 may be stored in the event data repository 220, and accordingly, the event scoring module 210 may retrieve the event data from the event data repository 220.

The event data may include a service score for the event, an event type of the event, and other data pertaining to the event. For example, the event data may further include a user identifier of the user operating the endpoint device 110 where the event occurred (i.e., the user experiencing the event). In particular, at block 305, the event scoring module 210 obtains event types 402 and service scores 404 for events from the event data repository 220.

At block 310, the event scoring module 210 determines whether the service score for the event exceeds a threshold service score for the event type. In particular, the event scoring module 210 obtains, from the evaluation data repository 222 in the memory 204, a threshold service score 406 based on the event type 402. Thus, different event types may have different threshold service scores according to the factors used to compute the service scores. For example, a VoIP call may have a threshold service score expressed as an r-factor of at least 70, while other types of events may have threshold services expressed as percentages or may have the threshold score vary based on the event type. The event scoring module 210 generates a binary evaluation 408 of the event (e.g., a pass or fail) based on the service score 404 and the threshold service score 406.

When the service score 404 of the event exceeds the threshold service score 406 for the event type 402 of the event, the event is assigned a pass indication at block 315. When the service score 404 does not exceed the threshold service score 406, the event is assigned a fail indication at block 320. The event scoring module 210 may also store the event and its associated binary evaluation 408 (e.g., the pass/fail indication) in the event data repository 220, for example, as part of the event data, for further processing.

As the method 300 iterates, the event scoring module obtains event types 402 and service scores 404 for each event in the event data repository 220. The event scoring module 210 evaluates each event based on the service scores 404 and the corresponding threshold service scores 406 and produces binary evaluations 408. In some examples, the event scoring module 210 may store the binary evaluations 408 associated with the events in the event data repository 220.

At block 325, the server 120, and in particular, the network scoring module 212 determines whether there are additional events which occurred on the network 104 which have not yet been assigned a binary evaluation 408. If the determination at block 325 is affirmative, the method 300 proceeds to block 330. At block 330, the event scoring module 210 obtains the next event and returns to block 305 to generate a binary evaluation for the next event. The method 300 continues in this manner until all events are assigned a binary evaluation 408.

If the determination at block 325 is negative (i.e., when all the events have been assigned a binary evaluation), the method 300 proceeds to block 335. At block 335, the server 120, and in particular, the network scoring module 212, determines whether the total number of events exceeds a threshold number of events. In particular, the network scoring module 212 may identify events occurring within a predetermined period of time to evaluate the network performance over said predetermined period of time. Accordingly, the network scoring module 212 may obtain the event times 410 from the event data repository 220. The network scoring module 212 may also obtain the predetermined period of time 412 and the threshold number of events 414 from the evaluation data repository 222. In particular, the threshold number of events 414 may represent a minimum number of events, for example to obtain a meaningful network score. The network scoring module 212 then determines whether the number of events having event times 410 within the predetermined period of time 412 exceeds the threshold number of events 414. That is, the network scoring module 212 may first filter the events based on the predetermined period of time 412 to obtain events occurring during the predetermined period of time 412 and subsequently determine whether the number of events occurring during the predetermined period of time 412 exceeds the threshold number of events 414.

If the determination at block 335 is negative, the method 300 proceeds to block 340 to wait for additional events to occur.

If the determination at block 335 is affirmative, the method proceeds to block 345. At block 345, the network scoring module 212 determines a network score 418 for the network 104 based on a number of failed events and a total number of events. In particular, the network scoring module 212 aggregates the binary evaluations 408 of the events which occurred on the network over the predetermined period of time to obtain a single network score 418 representing the performance of the network 104 as a whole.

For example, the network scoring module 212 may obtain a network score representing user experience of the network. Accordingly, the network scoring module 212 may identify a number of users experiencing at least one failed event based on (i) the binary evaluations of the events, as determined by the event scoring module 210, (and, in particular, events assigned a fail indication) and (ii) the user identifiers associated with the events. The network scoring module 212 may also identify a total number of users utilizing the network based on all events occurring on the network 104 and the event data associating the events to user identifiers. Specifically, the network scoring module 212 obtains user identifiers 416 associated with the events occurring in the predetermined period of time 412 and identifies the number of user identifiers F which are associated with at least one failed event in the predetermined period of time and the number of user identifiers T which are associated with at least one event in the predetermined period of time. The network scoring module 212 may compute a network score 418 based on the ratio of the number of user identifiers F which are associated with at least one failed event in the predetermined period of time to the number of user identifiers T which are associated with at least one event in the predetermined period of time. For example, the network score may be expressed as a percentage according to equation (1):

Network Score=(1−F/T)*100 (1)

In other examples, the network scoring module 212 may obtain a network score representing a success or failure rate of events as a whole, rather than in association with user identifiers. For example, the network score may be based on a ratio of the number of failed events in the predetermined period of time to a total number of events occurring in the predetermined period of time.

At block 350, the server 120, and in particular, the network evaluation module 214 outputs an indication of the network score.

In some examples, the network evaluation module 214 may first compare the network score computed at block 345 with a threshold network score. The threshold network score may represent, for example, a minimum desired quality of service for the network 104. In particular, the network evaluation module 214 receives the network score 418 from the network scoring module 212 and may obtain a threshold network score 420 from the evaluation data repository 222.

If the network score 418 exceeds the threshold network score 420, the network evaluation module 214 may simply store the network score 418 in the memory 204 for future reference without taking any remedial action to improve the network score 418. The network evaluation module 214 may then provide an output with an indication of the network score 418. For example, the network evaluation module 214 may generate a report including an indication of the network score, send a message to the client device 130 coupled to the server 120, or the like.

If the network score 418 does not exceed the threshold network score 420, the network evaluation module 214 may also generate a report including an indication of the network score, send a message to the client device 130 coupled to the server 120, or the like. That is, the network evaluation module 214 may output a supplementary indication that the network score is below the threshold network score with the indication of the network score. For example, the network evaluation module 214 may generate an alarm at an output device of the server 120 or provide a visual indication in the report or the message to the client device 130 of a sub-standard network score. In some examples, the network evaluation module 214 may obtain more than one threshold network scores 420 from the evaluation data repository 222 to obtain a more granular evaluation of the network 104.

For example, if the network score exceeds 95%, the network evaluation module 214 may consider the network quality to be “good” and may take no action. If the network score exceeds 90% but does not exceed 95%, the network evaluation module 214 may consider the network quality to be “satisfactory” and may generate a report indicating that the network quality may be improved. If the network score is below 90%, the network evaluation module 214 may consider the network quality to be “poor” and may generate a report indicating that the network quality may be improved, as well as triggering one or more alerting mechanisms or supplementary indications that the network score is below the threshold network score, including but not limited to, displaying or sounding an alarm at an output device of the server 120, or sending a message, such as an email, text message, or the like.

In other examples, other threshold network scores 420 may be utilized, or different combinations of responses may be triggered in response to the different threshold network scores.

In some examples, comparison of a score to a threshold may trigger automatic processes, such as a process that allocates additional memory, a process that allocates additional processing power (e.g., additional CPUs or cores), or a process that allocates additional network bandwidth. As such, improvement in network conditions may be made automatically without human input or intervention.

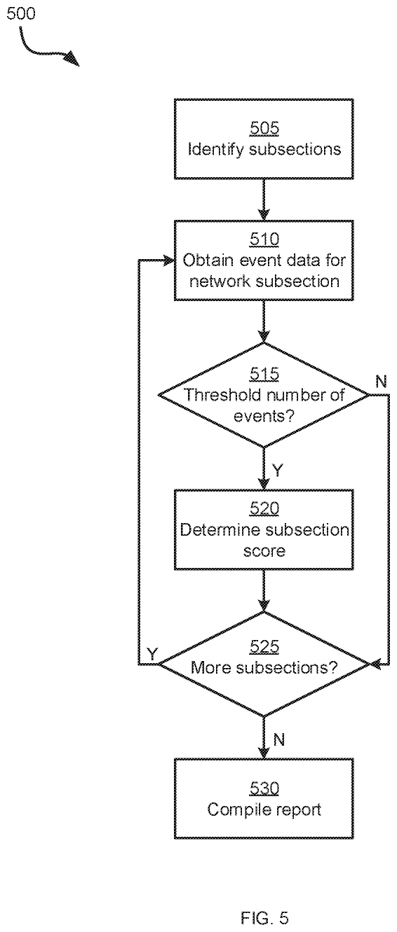

Referring now to FIG. 5, an example method 500 of generating a report during the method 300 is depicted. In particular, the method 500 is to analyze the network based on subsection analysis of the network. For example, the quality of service may not be homogeneous across the entire network, and accordingly, the server 120 may evaluate various subsections individually.

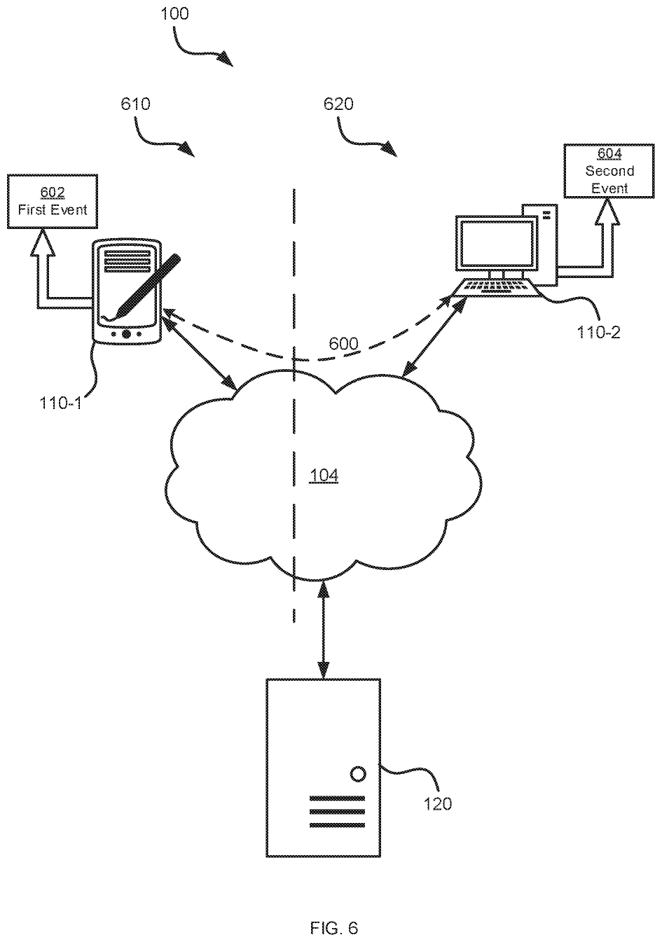

For example, referring to FIG. 6, a schematic of a communications event 600 between the first endpoint device 110-1 and the second endpoint device 110-2. For example, the network 104 may support a VoIP call between the first and second endpoint devices 110-1 and 110-2. Accordingly, two events may be recorded as being supported by the network 104—a first event 602 associated with the VoIP call as experienced by the first endpoint device 110-1, and a second event 604 associated with the VoIP call as experienced by the second endpoint device 110-2. The first event 602 may have event data identifying a first user (i.e., a user identifier) operating the first endpoint device 110-1, and a first service score. The second event 604 may have event data identifying a second user operating the second endpoint device 110-2, and a second service score. In particular, the first service score and the second service score may be different from one another. For example, the first event 602 may experience lag and have an r-factor of 60, while the second event 604 may be smoother and have an r-factor of 80.

Returning to FIG. 5, at block 505, the server 120, and in particular, the subsection evaluation module 216 identifies one or more subsections of the network 104. For example, referring to FIG. 6, the subsection evaluation module 216 may identify a first subsection 610 including the first endpoint device 110-1, and a second subsection 620 including the second endpoint device 110-2. The subsections may represent, for example, distinct offices of a company's network, distinct regions or sub-networks provided by the network, or the like. In still further examples, the subsections may represent different services provided by the network 104.

Returning again to FIG. 5, at block 310, the subsection evaluation module 216 obtains the event data associated with events corresponding to a particular subsection. For example, the subsection evaluation module 216 may obtain event data associated with the first subsection 610 to evaluate the first subsection. The event data obtained at block 310 may be the binary evaluations determined during the method 300. Accordingly, the subsection evaluation module 216 may retrieve the binary evaluations from the event data repository 220. In other examples, the subsection evaluation module 216 may obtain the raw event data (i.e., the service scores and event types for events corresponding to the subsection), and may determine the binary evaluations for the events associated with the selected subsection, for example by a similar methodology as in the method 300.

At block 515, the subsection evaluation module 216 determines whether a threshold number of events are associated with the subsection. If the determination is negative, the method 500 proceeds directly to block 325. If the determination is affirmative, the method 500 proceeds to block 520.

At block 520, the subsection evaluation module 216 determines the subsection score for the subsection. In particular, the subsection score is based on a number of failed events associated with the subsection and a total number of events associated with the subsection. The subsection evaluation module 216 aggregates the binary evaluations of the events which occurred on the network over the predetermined period of time to obtain a single subsection score representing the performance of the subsection.

For example, the subsection evaluation module 216 may obtain a subsection score representing user experience of the network within the subsection over the predetermined period of time. The subsection evaluation module 216 may identify a number of users experiencing at least one failed event in the subsection based on user identifiers associated events assigned the fail indication. The subsection evaluation module 216 may also identify a number of users utilizing the subsection based on user identifiers associated at least one event. The subsection score may then be computed in accordance with equation (1).

At block 525, the subsection evaluation module 216 determines whether there are more subsections left to score. If the determination is affirmative, the method 500 returns to block 510 to obtain event data for the next subsection. If the determination is negative, the method 500 proceeds to block 530. In some examples, at block 525, the subsection evaluation module 216 may iteratively sub-divide and evaluate the subsections in more granular portions. That is, the subsection evaluation module may subdivide the subsections into subdivisions and determine subdivision scores for each of the subdivisions based on a number of failed events associated with the subdivision and a total number of events associated with the subdivision.

At block 530, the subsection evaluation module 216 compiles a report. In particular, the subsection evaluation module 216 generates a report indicating the subsection score for each of the subsections of the network 104. For example, the report may display an indication of each subsections, any further subdivisions of the subsection, and the corresponding subsection score associated with the subsection or subdivision. In some examples, the report may indicate that no subsection score could be computed (i.e. a NULL subsection score), for example, based on the subsection not having the threshold number of events occurring. In other examples, subsections with no events associated may indicate a subsection score of 100% when no events were associated with the subsection (i.e., indicating that no problems occurred for that subsection). In particular, the report may highlight subsections which are below a threshold subsection score to indicate problem areas. The method 500 thus provides a granular evaluation of the different subsections of the network 104 to determine where problems are occurring.

For example, if many of the endpoint devices in the first subsection 610 are experiencing network problems, and the endpoint devices in the second subsection 620 are experiencing good network connection, the network score for the entire network 104 may still be below the threshold score. When the subsections are evaluated, the subsection scores may highlight deficiencies in network performance of the first subsection 610, while providing an indication of sufficient network performance in the second subsection 620. The subsection evaluations may therefor provide a good indication of where resources are to be allocated to improve network performance.

The system may therefore provide an indication of network performance in an intuitive manner and representing the network as a whole. In particular, the network performance may be tied to user identifiers to obtain a representation of user experience of network performance. Additionally, the system may provide insights into subsections to enable granular evaluation of the network.

The scope of the claims should not be limited by the embodiments set forth in the above examples but should be given the broadest interpretation consistent with the description as a whole.

1. A system comprising:
a plurality of endpoint devices;
a network supporting events on the network, each event occurring at one of the plurality of endpoint devices;
a network evaluation server coupled to the network, the server configured to:
for each event:
obtain a service score, an event type, and a user identifier for the event; and
when the service score for the event does not exceed a threshold service score for the event type, assign a fail indication for the event;
determine a network score based on (i) a number of user identifiers associated with at least one failed event and (ii) a total number of user identifiers associated with at least one event; and
output an indication of the network score.

2. The system of claim 1, wherein the server is configured to determine the network score according to the equation (1−(F/T))*100, wherein F represents the number of user identifiers associate with at least one failed event and T represents the total number of user identifiers associated with at least one event.

3. The system of claim 1, wherein the server is configured to determine the network score when the total number of events exceeds a threshold number of events.

4. The system of claim 1, wherein the server is configured to determine the network score for events occurring within a predetermined period of time.

5. The system of claim 1, wherein the server is configured to one or more of:
generate a report including the indication of the network score;
generate an alarm at an output device associated with the server; and
send a message to a client device.

6. The system of claim 1, wherein the server is further configured to:
identify one or more subsections of the network; and
for each subsection of the network, determine a subsection score based on a number of failed events associated with the subsection and a total number of events associated with the subsection.

7. The system of claim 6, wherein the subsections comprise one or more of: distinct offices associated with the network; distinct regions of the network; distinct sub-networks of the network; and different services supported by the network.

8. The system of claim 6, wherein the server is configured to determine the subsection score when the total number of events associated with the subsection exceeds a threshold number of events.

9. The system of claim 1, wherein the server is to:
compare the network score with a threshold network score; and
when the network score is below a threshold network score, output a supplementary indication that the network score is below the threshold network score.

10. A method comprising:
for each of a plurality of events on a network:
obtaining a service score and an event type for the event; and
when the service score for the event does not exceed a threshold service score for the event type, assigning a fail indication for the event;
determining a network score for the network based on (i) a number of failed events and (ii) a total number of events; and
outputting an indication of the network score.

11. The method of claim 10, wherein determining the network score comprises:
filtering the plurality of events to obtain events occurring during a predetermined period of time; and
determining the network score for the network during the predetermined period of time.

12. The method of claim 10, wherein determining the network score comprises:
identifying a number of users experiencing at least one failed event based on user identifiers associated with events assigned the fail indication;
identifying a number of users experiencing at least one event based on user identifiers associated with at least one event; and
determining the network score based on (i) the number of users experiencing at least one failed event and (ii) the number of users experiencing at least one event.

13. The method of claim 12, wherein determining the network score is based on the equation (1−(F/T))*100, wherein F represents the number of users experiencing at least one failed event and T represents the number of users experiencing at least one event.

14. The method of claim 10, wherein determining the network score is performed when the total number of events exceeds a threshold number of events.

15. The method of claim 10, wherein outputting the indication of the network score comprises one or more of:
generating a report including the indication of the network score;
generating an alarm at an output device; and
sending a message to a client device.

16. The method of claim 10, further comprising:
identifying one or more subsections of the network; and
for each subsection of the network, determining a subsection score based on a number of failed events associated with the subsection and a total number of events associated with the subsection.

17. A method comprising:
determining a network score for a network based on a number of failed events and a total number of events supported by the network;
identifying one or more subsections of the network;
for each subsection of the network, determining a subsection score based on a number of failed events associated with the subsection and a total number of events associated with the subsection; and
outputting an indication of the subsection score for each of the one or more subsections of the network.

18. The method of claim 17, further comprising, when the total number of events associated with the subsection is below a threshold number of events, assigning the subsection score to be NULL.

19. The method of claim 17, further comprising, when the total number of events associated with the subsection is below a threshold number of events, assigning the subsection score to be 100%.

20. The method of claim 17, further comprising:
subdividing at least one of the one or more subsections into one or more subdivisions; and
for each subdivision, determining a subdivision score based on a number of failed events associated with the subdivision and a total number of events associated with the subdivision.
